(19) United States
(12) Patent Application Publication
(10) Pub. No.: US 2003/0123635 A1
(43) Pub. Date: Jul. 3, 2003

(54) System and method for server redundancy in IP-based telephone system

(75) Inventor: Young-Sin Lee, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 10/330,203

(22) Filed: Dec. 30, 2002

(30) Foreign Application Priority Data
Dec. 31, 2001 (KR) 89271/2001

(51) Int. Cl. H04M 7/00

(52) U.S. Cl. 379/220.01

(57) ABSTRACT

A method for providing seltzer redundancy operates in a backup mode and a redundancy mode. In backup mode, a plurality of servers are divided into a primary server and backup servers and terminals are registered in a Zone only on the primary server. In load-balancing mode, terminals are registered in the Zone as dispersed on a plurality of servers. The backup mode further includes a process for avoiding primary server conflict, and in the load-balancing mode an information managing server for controls terminal registration information and stores the registration information with a server ID. Through this method, the problem of AGK-conflict is overcome. Moreover, improved AGK signaling is provided for a case where sending/receiving terminals are registered on different AGKs in an H.323 system.

### BACKGROUND OF THE INVENTION

1. Field of the Invention

The present invention relates to an IP_based telephone system, and more particularly to a method for stability and redundancy of a gate keeper suggested by ITU-T H.323.

2. Background of the Related Art

In order to use a VoIP server, it is important for the server to be stable. Server redundancy is a method for providing stability of the server. Redundancy does not only provide a backup function, it also performs the function of distributing loads of the server to various places. The standard H.323 uses an alternative gatekeeper (AGK) signaling to provide server redundancy.

FIG. 1 shows an example of an H.323 system which includes a general data network such as a local area network (LAN) divided into a plurality of zones to be managed. Each respective H.323 zone 10 is divided into a plurality of service areas (dotted ovals) to be managed. In each service area, there is a server (hereinafter, referred to as ‘gatekeeper’, 20), and the server provides respective terminals with effective VoIP service.

The terminals 30 in the H.323 zone are registered on the gatekeeper which manages the area in which the terminal is included, and perform a number of services. In addition, since the gatekeeper 20 performs call processing instead of the terminal 30, the terminal implemented with only basic stacks can be provided with various additional services.

An AGK is a physical or logical device for processing RAS (registration, admission, status) signaling in one zone, and an RAS function is performed by a plurality of AGKs. If AGK signaling is used, each terminal is able to select another AGK which can be communicated for forwarding the call when the AGK(on which the terminal is registered does not respond or when the AGK transmits an xRJ(rejection) message. As a result, stability and functioning of the system can be ensured.

AGK signaling can be applied to a system higher than H323v2 using an “AlternateGK” and an “AltGKInfo” of H.225v2. “AlternateGK” is information carried on an xCF (confirm) message which is transmitted from the AGK to the terminal. This information comprises ‘RAS address information of related AGks’ and ‘priority information’ representing priorities among the AGKs.

The “AltGKInfo” is information carried on the xRJ message transmitted from the AGK to the terminal, and comprises an ‘AlternateGK’ field and an ‘altGKisPermanent’ field. The ‘altGKisPermanent’ is a field representing whether or not signaling will be continuosly performed with the selected AGK, when the terminal performs RAS signaling. That is, when the altGKisPermanent value is FALSE, the terminal should perform signaling with a different AGK for the respective RAS message, and when the value is TRUE the terminal should perform all RAS signaling with one AGK.

In the AGK structure, when the terminal receives a confirmation message (GCF or RCF), the terminal stores AGK list information included in the message and requests the AGK of the highest priority to be registered with reference to the above information. Also, in case that the AGK on which the terminal is registered does not respond, the corresponding terminal requests the AGK(of the highest priority in the AGK list information, which is received recently, to be registered, or performs an AGK finding process (GRQ/GCF) again.

The above ITU-T H.323 explained above suggests a redundancy structure which ensures the stability and the functional capability of the VoIP server. However, in order to support this redundancy structure, it would be desirable for. AGK signaling to support the following functions.

First, in a backup mode, it would be desirable for polling signaling to be performed between AGKs. It would also be desirable to have a method for redirecting a request message of registration when the request message is sent to an AGK of a low level priority(or backup gatekeeper)

Second, in a load balancing mode, it would be desirable to perform signaling for performing a method for sharing registration information of terminals by the AGKs in order to prevent the terminal from being registered on two or more AGKs. Also, it would be desirable to perform signaling for realizing a method of commonly setting a call by the AGKs in case that a sender and a receiver are registered on different AGKs from each other.

Presently, AGK signaling suggested by the ITU-T H.323 does not have regulations for above two items.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

An object of the present invention is to provide a method providing for server redundancy in an IP_based telephone system which is able to solve an AGK conflict problem.

Another object of the present invention is to provide a method for performing server redundancy in an IP_based telephone system which suggests desirable AGK signaling when sender/receiver terminals are registered on different AGKs.

To achieve these and other objects of the present invention, a method is provided for performing server redundancy by dividing a plurality of servers into a primary server and backup servers in a backup mode and registering a terminal in a Zone only on the primary server, and registering terminals in the Zone on a plurality of servers in a load balancing mode.

In the load-balancing mode a call-setting, signaling operation is performed which includes comprises: a step of registering a terminal on a sending server; a step of transmitting approval request message of the registered terminal to the sending server; a step of performing a certification signaling for a receiving terminal of the message, and after that, permitting the approval request of the sending terminal; a step of transmitting a setup message of the approved terminal to the sending server; a step of performing a certification signaling for the receiving terminal of the setup message and after that, transmitting the setup message to the receiving terminal; a step of transmitting an approval request message of the receiving terminal to a receiving server; a step of performing a certification signaling for the receiving party terminal (sending terminal) of the approval request message of the receiving terminal, and permitting the approval request of the receiving terminal; and a step of transmitting a call connection message from the approved receiving terminal to the sending server, and setting a call between the sending/receiving terminals.

The RAS signaling of the backup mode comprises: a step of collecting status information of other servers when the terminal requests the backup server to be registered; a step of setting the backup server as a primary server (New) when there is no status information of the primary server (Old) in the collected information; a step of registering the terminal on the primary server (New), transmitting information of the primary server (New) to other servers, and identifying whether the primary server (Old) exists again; and a step of setting a call by permitting an approval request and a call setting request of the sending terminal, when primary server (Old) does not exist.

If there is the status information of the primary server (Old), the above process further comprises: a step of transmitting a registration reject message including the information of the primary server (Old) to the sending terminal; and a step of registering the terminal on the primary server (Old).

If the primary server (Old) is found when the identification of primary server (Old) is made again, a process for avoiding primary server conflict is performed.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is an exemplary view showing an H.323 Zone;

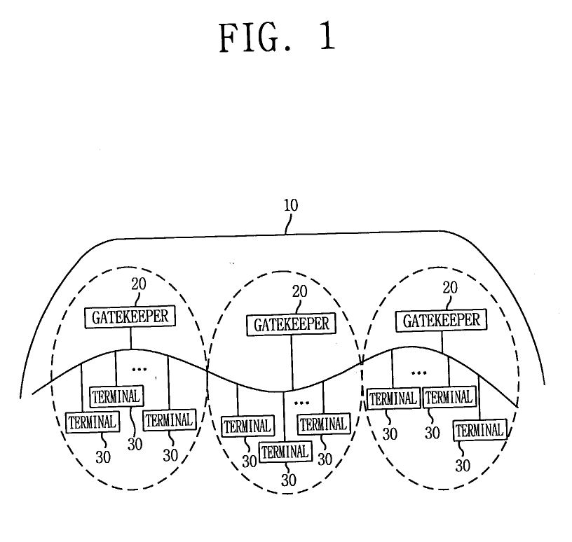

FIG. 2 is a flow chart showing an RAS signaling in a backup mode according to the present invention; and

FIG. 3 is a flow chart showing a call setting signaling in a load balancing mode according to the present invention.

### DETAILED DESCRIPTION OF PREFERRED EMBODIMENTS

A method for providing server redundancy according to the present invention provides two kinds of redundancy modes, one is a backup mode and the other is a load-balancing mode. The backup mode provides higher stability and may be effectively used in a small communication environment. The load-balancing mode has relatively low stability compared to the backup mode, however it allows a large scale of communication network to be controlled effectively with a low-price server computer. These two modes may be applied alternately according to the communication environment.

Also, these modes all support a gatekeeper which manages an outer Zone and an H.323 inter-Zone communication. The gatekeeper may be divided into a primary gatekeeper (hereinafter, referred to as “PGK”) and a backup gatekeeper (hereinafter, referred to as “BGK) in the backup mode. The PGK is a gatekeeper which performs present functions. The BGK does not perform the ususal functions of a gatekeeper, and is operated as the PGK if there is no PGK or if there is a problem in operation. That is, some or all the system terminals may be registered only on the PGK in the backup mode.

On the contrary, all gatekeepers perform as the PGK in the load-balancing mode and process a call as distributing. That is, the terminals are not registered only on a certain gatekeeper in the load-balancing mode, but are registered as dispersed to all gatekeepers. Therefore, the PGK only processes calls in backup mode, and a plurality of gatekeepers distribute and process calls in the load-balancing mode.

A method for performing server redundancy according to a preferred embodiment of the present invention divides the signaling, which is performed between the gatekeepers, into two kinds in order to support the two redundancy modes. One kind is signaling for inducing the terminal to be registered only on the PGK, and the other is signaling for making a plurality of gatekeepers perform the call process. The signaling for inducing the terminal to be registered on the PGK will be described as follows.

As previously described, only one gatekeeper performs call signaling with the terminal in backup mode. That is, only the PGK performs the call signaling with the terminal. Therefore, the PGK performs a polling function for identifying whether the PGK exists, and is operated as the PGK only when the PGK does not respond. The BGK preferably performs its polling operation when booting is performed, and when the BGK receives a gatekeeper discovery request message (GRQ), a registration request message (RRQ) and an approval request message (ARQ) from the terminal. The BGK sends a status information request (IRQ) signal to the PGK for polling. In addition, after a predetermined time has passed, if the BGK receives a response signal (IRR) from the PGK, the BGK decides that the PGK exists. On the contrary, if the BGK does not receive the IRR until an IRQ timer is ended, then, corresponding BGK is operated as the PGK.

If the PGK exists, the terminals transmit xRQ messages to the BGK receive xRJ messages. In addition, the BGK carries the information of PGK on the xRJ message to induce the terminal receiving the PGK information to be registered on the PGK. If the PGK does not exist, that is, if the BGK is not able to receive the IRR of the PGK, the BGK permits the registration of the terminal by sending an xCF to the terminal, and after that performs as the PGK. The PGK sends the xCF message carrying BGK information to the terminal.

Delay or loss of the IRR causes a case that two or more AGKs are operated as the PGK. For example, if the IRR transmitted by the PGK is lost on its way, the BGK which transmitted the IRQ signal is operated as the PGK. On the contrary, in case that the IRQ signal sent by the BGK is not reached to the PGK, the same phenomenon is caused. Therefore, PGK conflict that two or more AGKs are existed as the PGK at the same time is generated.

The PGK conflict may be solved by using a time point when the AGK becomes the PGK. That is, the AGK which became the PGK due to the delay or loss of the IRR notifies other AGKs of the time (pgk-time) when it becomes the PGK preferably using an H.225 Nonstandard message. The actual PGK compares the pgk-time of the received Nonstandard message to the pgk-time of itself, and is operated as the BGK if the pgk-time of the message is earlier than that of itself. However, if the pgk-time of itself is earlier than that of the message, the PGK sends a second Nonstandard message to the sending AGK to make the sending AGK operated as the BGK again.

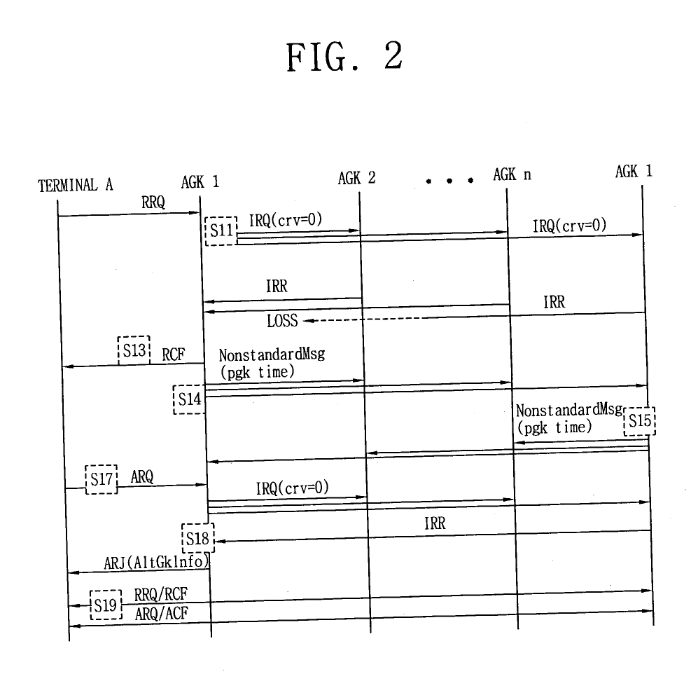

FIG. 2 is a flow chart showing RAS signaling performed in the backup mode according to the present invention. This figure also shows an avoidance method of PGK conflict generated during RAS signaling. As shown, RAS signaling according to the present invention includes collecting status information of other AGKs (AGK 2˜AGK n) when the sending terminal (terminal A) requires the AGK 1 to be registered; setting the AGK1 as a new PGK when there is no status information of the PGK in the collected information, registering the sending terminal (terminal A) on the new PGK, transmitting the information, about the new PGK to other AGKs (AGK 2˜AGK n), and identifying again whether or not the PGK exists. Also, the step of permitting the approval request and a call setting request of the sending terminal (terminal A) may be performed to set a call.

The signaling process further includes transmitting registration reject message including the PGK information to the sending terminal (terminal A) if there is the status information about the PGK in the collected information, and a step of registering the sending terminal (terminal A) on the PGK(. If the PGK is found when the identification process for the PGK is performed, the PGK conflict avoidance process is performed.

The PGK conflict avoiding process includes comparing pgk-times of the PGK and of the new PGK, ending a primary conflict avoiding process, when the pgk-time of the new PGK is longer than that of the PGK and a transmitting a rejection message (xRJ) including the PGK information to the sending terminal (terminal A) when the pgk-time of the PGK is longer than that of the new PGK, and registering the sending terminal (terminal A) on the PGK.

The method for avoiding the PGK conflict generated during the RAS signaling will now be described in more detail as follows.

The AGK1 which received the RRQ message from the terminal A sends the IRQ signal to the AGK in order to identify whether or not the PGK exists (S11). In case that a call reference value (crv) of the IRQ signal is 0, the IRQ signal is transmitted to all AGKs (AGK2˜AGKn).

The AGKs which received the IRQ signal transmit IRR(response signal) to the AGK1. If there is no IRR of the PGK among the received IRRs, the AGK1 permits the registration of terminal A in order to be operated as the PGK (S13), and notifies the AGK(2˜n) that the AGK1 will be operated as the PGK (S14). However, the actual PGK which received the Nonstandard message compares the pgk-time of the AGK1 to the pgk-time of itself. If the pgk-time of the actual PGK is larger than that of the AGK1, the PGK transmits Nonstandard message carrying the pgk-time of the PGK to other AGKs (AGK1˜AGKn) (S15). The AGK1 also compares the pgk-time of the actual PGK included in the Nonstandard message to the pgk-time of itself. Then, if the pgk-time of the AGK1 is smaller than that of the PGK, the AGK1 is operated as the BGK.

On the other hand, the terminal A registered on the AGK1 transmits the ARQ message to the AGK1 in order to set a call (S17). The AGK1 which received the ARQ performs the polling again in order to identify whether or not the PGK exists, that is, whether or not the PGK is operated effectively. In addition, if the PGK exists, the AGK1 sends the ARJ message to the terminal A (S18). At that time, the AGK1 sends the ARJ message with the AltGKInfo. Then, the terminal A performs RRQ/RCF/ARQ/ACF processes with the PGK to set a call (S19). From the above process S19, the polling operation of the BGK is not required.

In the toad-balancing mode, since all AGKs are operated as the PGK, the terminals are dispersed to various AGKs to be registered. Therefore, the AGK1 which received the xRQ message does not perform the polling for the AGK(2˜n), but transmits the xCF message directly to the terminal. However, in case of the load balancing mode, since the previous terminal registration information is re-loaded when the AGK is re-booted, there may be a problem that one terminal is registered on two or more AGKs if the registration information of the terminal is updated during IDLE status of AGK due to overcrowding or functional error or during re-booting the AGK.

An IP_based telephone system according to the present invention can solve the problem of terminal double-registration using a method of not reading the registration information of the terminal when the AGK is booted (or initialized) or using a method of realizing an information managing server for managing the registration information of the terminal and storing the registration information with an AGK ID. A call setting signaling in which a call is processed by a plurality of gatekeepers will be described as follows.

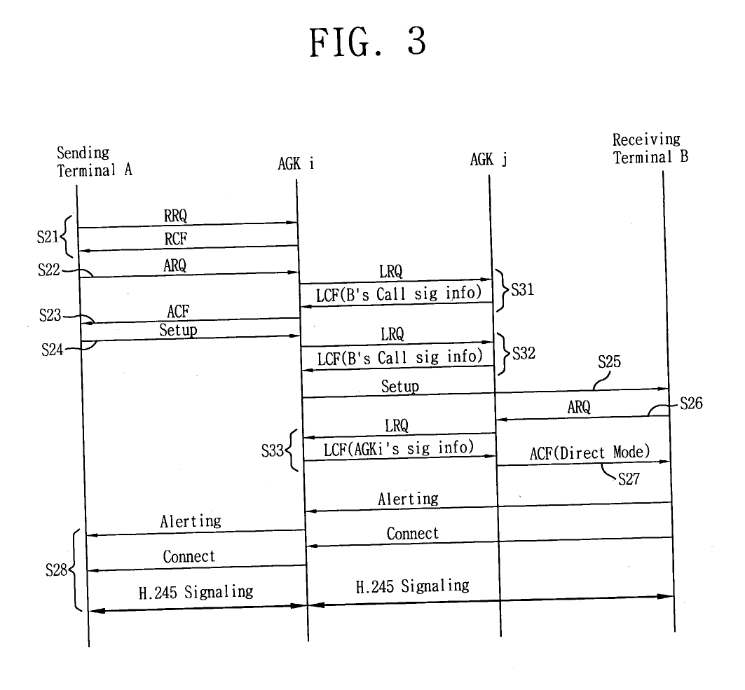

FIG. 3 is a flow chart shoving steps included in a call setting signaling method performed in the load-balancing mode includes requesting a terminal on a sending AGK (AGKi) (S21), transmitting an approval request message of the registered terminal to the sending AGK (AGKi) (S22), and performing a certification signaling for a receiving terminal of the message (S31). After this step, the following steps are performed: permitting the approval request of the sending terminal (S23), transmitting a setup message of the approved terminal to the sending AGK (AGKi) (S24) performing certification signaling for the receiving terminal of the setup message (S32) and after that, transmitting the setup message to the receiving terminal (S25), transmitting an approval request message of the receiving terminal to a receiving AGK (AGKi) (S26), performing a certification signaling for a receiving party terminal (sending terminal) of the approval request message of the receiving terminal (S33), and after that, permitting the approval request of the receiving terminal (S27). Following these steps, a call connecting message is transmitted from the approved receiving terminal to the sending AGK (AGKi), and a call is set between the sending/receiving terminals (S28).

In backup mode, since all terminals are registered on one AGK, the call setting signaling which is applied when one AGK manages the Zone is applied to the backup mode. However, in the load balancing mode, since the terminals are registered as dispersed on a lot of AGKs, signaling passing over two or more gatekeepers (AGKi, AGKj) is required even in the call between the terminals in same Zone.

In H.323, the signaling between AGKs (AGKi & AGKj) located on different Zones from each other is based on LRQ/LCF. The LRQ/LCF signaling (or certification signaling) may be used to obtain signaling information of a terminal which is not registered, and also can be used to certify. The AGKi and the AGKj check continuously whether or not the sending terminal and the receiving terminal are registered thereon when the RAS and Q.931 signaling are processed. Therefore, whenever certifications for the non-registered terminal are required, the LRQ/LCF signaling is performed, and the signaling of corresponding call is started when the LCF message is received.

As shown in FIG. 3, sending AGK (AGKi) performs the LRQ/LCF signaling respectively when a receiving terminal of an ARQ message sent by the registered sending terminal is not registered (S31), when a receiving terminal of the setup message sent by the registered sending terminal is not registered (S32), and when the sending terminal of the setup message which is received from the sending AGK (AGKi) is approved.

The signaling in FIG. 3 is applied between inter-Zone. However, the receiving party AGK in the load balancing mode transmits the LCF message as carrying a signaling address of the receiving terminal so as to perform a direct call between the terminals. Therefore, there is no transmission delay due to unnecessary signaling between the AGK and AGK. However, since the receiving part gatekeeper in the inter-Zone signaling loads the LCF message with the signaling address of itself, the transmission delay is generated according to the signaling between the gatekeeper and the gatekeeper.

As described above, according to the method for providing server redundancy of the present invention, the backup mode which can be applied to a data network of small size has higher stability and the load balancing mode which is able to control a data network of larger size effectively with the device of lower price can be applied selectively according to communication environments.

Also, the AGK conflict problem which is expected in the redundancy structure can be solved, and the AGK signaling for a case that the sending/receiving terminals are registered on different AGKs from each other, which is not suggested in the present H.323, is suggested according to the present invention.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for providing server redundancy in an IP_based telephone system, comprising:
in a backup mode, dividing a plurality of servers into a primary server and backup servers and registering terminals in a zone only on the primary server; and
in a load-balancing mode, registering terminals in the zone as dispersed on a plurality of servers.

2. The method of claim 1, wherein the backup mode and the load balancing mode are applied selectively according to a communication environment.

3. The method of claim 1, wherein the backup mode comprises a process for avoiding primary server conflict.

4. The method of claim 3, wherein the process for avoiding primary server conflict comprises:
comparing life times of a primary server (Old) and of a primary server (New);
ending the avoiding process when the life time of the primary server (New) is longer than that of the primary server (Old); and
transmitting a rejection message (xRJ) including information of the primary server (Old) to a sending terminal if the life time of the primary server (Old) is longer than that of the primary server (New), and registering the sending terminal on the primary server (Old).

5. The method of claim 1, wherein in the load-balancing mode, an information managing server manages registration information of the terminal, and stores the registration information of the terminal with a server ID.

6. The method of claim 1, wherein a call setting signaling of the backup mode comprises:
registering a terminal on a sending server;
transmitting an approval request message of the registered terminal to the sending server;
performing a certification signaling for a receiving terminal of the message, and after that, permitting the approval request of the sending terminal;
transmitting a setup message of the approved terminal to the sending server;
performing a certification signaling for the receiving terminal of the setup message, and after that, transmitting the setup message to the receiving terminal;
transmitting an approval request message of the receiving terminal to a receiving server;
performing a certification signaling for a receiving party terminal (sending terminal) of the approval request message of the receiving terminal, and after that, permitting the approval request of the receiving terminal; and
transmitting a call connecting message from the approved receiving terminal to the sending server, and setting a call between the sending/receiving terminals.

7. The method of claim 6, wherein the certification signaling is performed when the receiving party terminal of the received message is not registered on the sending party server.

8. The method of claim 6, wherein the sending server performs a direct call with the receiving terminal.

9. The method of claim 8, wherein the receiving server transmits a signaling address of the receiving terminal to the sending server when the certification signaling is performed.

10. The method of claim 6, wherein the certification signaling is a signaling between servers, and uses an LRQ/LCF message.

11. The method of claim 1, wherein an RAS signaling of the backup mode comprises:
collecting status information of other servers, when a terminal requires the backup server to be registered;
setting the backup server as a primary server (New) when there is no status information of a primary server (Old);
registering the terminal on the primary server (New), transmitting information of the primary server (New) to other servers, and identifying again whether or not the primary server (Old) exists; and
permitting an approval request and a call setting request of the terminal when the primary server (Old) does not exist to set a call.

12. The method of claim 11 further comprising:
transmitting a registration rejection message including the information of the primary server (Old) to the terminal when there is the status information of the primary server (Old) in the collected information; and
registering the terminal on the primary server (Old).

13. The method of claim 11, wherein a process for avoiding primary server conflict is performed if the primary server (Old) is found when the identification for the primary server (Old) is performed.
